(19) United States
(12) Patent Application Publication
(10) Pub. No.: US 2018/0121663 A1
(43) Pub. Date: May 3, 2018

(54) Sharing Protection for a Screen Sharing Experience

(71) Applicant: Microsoft Technology Licensing, LLC, Redmond, WA (US)

(72) Inventors: Amer Aref Hassan, Kirkland, WA (US); William George Verthein, Sammamish, WA (US); Andrew Nicholas Paul Smith, London (GB)

(73) Assignee: Microsoft Technology Licensing, LLC, Redmond, WA (US)

(21) Appl. No.: 15/340,763

(22) Filed: Nov. 1, 2016

(51) Int. Cl. G06F 21/62; G06F 21/84; H04L 29/06

(52) U.S. Cl. CPC G06F 21/62; H04L 63/06; G06F 21/84

(57) ABSTRACT

Techniques for sharing protection for a screen sharing experience are described. In at least some embodiments, a screen sharing experience involves a user sharing portions of their display screen with other users as part of a communication session. According to various embodiments, a user that is sharing their screen with other devices as part of a screen sharing experience can protect a portion of the screen from being shared by designating the portion as sharing protected. Thus, content from the identified portion of the user's screen is encrypted to prevent other devices that are unable to decrypt the content from viewing the content. According to one or more embodiments, a user can be designated as sharing privileged such that the user is permitted access to an encryption key to decrypt and view sharing protected as part of a screen sharing experience.

### BACKGROUND

Modern communication systems have an array of capabilities, including integration of various communication modalities with different services. For example, instant messaging, voice/video communications, data/application sharing, white-boarding, and other forms of communication may be combined with presence and availability information for subscribers. Such systems may provide subscribers with the enhanced capabilities such as providing instructions to callers for various status categories, alternate contacts, calendar information, and comparable features. Furthermore, collaboration systems enabling users to share and collaborate in creating and modifying various types of documents and content may be integrated with multimodal communication systems providing different kinds of communication and collaboration capabilities. Such integrated systems are sometimes referred to as Unified Communication and Collaboration (UC&C) systems.

While UC&C systems provide for increased flexibility in communications, they also present a number of implementation challenges. For instance, a user may wish to share screen content to different devices engaged in UC&C communication. The user, however, may wish to protect some screen content from being shared. Enabling concurrent screen sharing and content protection presents a number of implementation challenges.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for sharing protection for a screen sharing experience are described. In at least some embodiments, a screen sharing experience involves a user sharing portions of their display screen with other users as part of a communication session. According to various embodiments, a user that is sharing their screen with other devices as part of a screen sharing experience can protect a portion of the screen from being shared by designating the portion as sharing protected. Thus, content from the identified portion of the user's screen is encrypted to prevent other devices that are unable to decrypt the content from viewing the content. According to one or more embodiments, a user can be designated as sharing privileged such that the user is permitted access to an encryption key to decrypt and view sharing protected as part of a screen sharing experience.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Identical numerals followed by different letters in a reference number may refer to difference instances of a particular item.

FIG. 1 is an illustration of an environment in an example implementation that is operable to employ techniques discussed herein.

FIG. 2 depicts an example implementation scenario for protecting content during a screen sharing experience in accordance with one or more embodiments.

FIG. 3 depicts an example implementation scenario for protecting content during a screen sharing experience in accordance with one or more embodiments.

FIG. 4 depicts an example implementation scenario for enabling sharing protected content to be accessible by a privileged user during a screen sharing experience in accordance with one or more embodiments.

FIG. 5 depicts an example implementation scenario for designating a sharing protected region in accordance with one or more embodiments.

FIG. 6 depicts an example implementation scenario for designating a sharing protected region in accordance with one or more embodiments.

FIG. 7 depicts an example implementation scenario for designating a user set that is permitted to view a sharing protected region in accordance with one or more embodiments.

FIG. 8 depicts an example implementation scenario for designating users that are sharing privileged in accordance with one or more embodiments.

FIG. 9 is a flow diagram that describes steps in a method for controlling access to content of a sharing protected region in accordance with one or more embodiments.

FIG. 10 is a flow diagram that describes steps in a method for controlling access to content of a sharing protected region in accordance with one or more embodiments.

FIG. 11 is a flow diagram that describes steps in a method for visually obscuring a sharing protected region in accordance with one or more embodiments.

FIG. 12 illustrates an example system and computing device as described with reference to FIG. 1, which are configured to implement embodiments of techniques described herein.

### DETAILED DESCRIPTION

Techniques for sharing protection for a screen sharing experience are described. In at least some implementations, a screen sharing experience involves a user sharing portions of their display screen with other users as part of a communication session. A communication session, for instance, refers to a real-time exchange of communication media between different communication endpoints. Examples of a communication session include a Voice over Internet Protocol (VoIP) call, a video call, text messaging, a file transfer, content sharing, and/or combinations thereof. In at least one implementation, a communication session represents a Unified Communication and Collaboration (UC&C) session.

According to various implementations, a user that is sharing their screen with other devices as part of a screen sharing experience wishes to protect a portion of the screen from being shared. For instance, a portion of their screen may be displaying sensitive and/or personal information that the user doesn't wish to share. Accordingly, the user invokes a sharing protect functionality to enables the user to identify a portion of their screen that is not to be shared with the other devices. The user, for instance, can draw a protection zone around a portion of their screen that they wish to sharing protect. Other ways of designating a particular portion of a display as sharing protected are described below. Thus, the identified portion of the user's screen is encrypted while other portions are shared in the clear as part of the screen sharing experience.

According to one or more implementations, a user can be designated as sharing privileged such that the user is permitted to view content that is designated as sharing protected as part of a screen sharing experience. For instance, a sharing user that specifies a portion of their display screen as sharing protected as part of a screen sharing experience can identify a participant in the screen sharing experience as sharing privileged. Thus, a device associated with the privileged participant has access to an encryption key such that the device can decrypt content from the sharing protect portion of the screen and display the decrypted content in the clear. Other non-privileged participants in the screen sharing experience, however, do not have access to the encryption key and thus cannot decrypt and view the protected content. In this way, a user can protect certain screen content from general sharing, while designating a set of privileged users that are permitted to view the content.

Accordingly, techniques for sharing protection for a screen sharing experience described herein enhance the ability for users to protect sensitive content and data during a screen sharing experience, thus improving data security for sensitive user data and preventing undesired exposure of sensitive user content. The described techniques also improve computing device performance during a screen sharing experience by enabling encryption keys for decrypting protected content to be efficiently distributed to privileged devices.

In the following discussion, an example environment is first described that is operable to employ techniques described herein. Next, some example implementation scenarios are described in accordance with one or more embodiments. Following this, some example procedures are described in accordance with one or more embodiments. Finally, an example system and device are described that are operable to employ techniques discussed herein in accordance with one or more embodiments. Consider now an example environment in which example implementations may by employed.

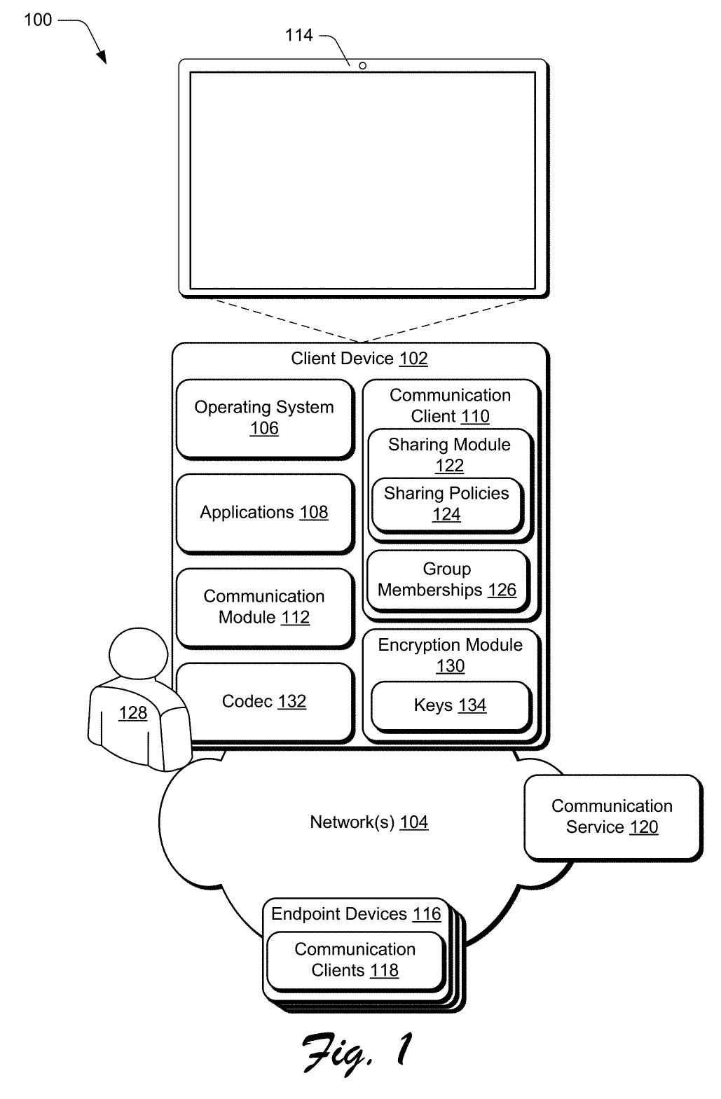

FIG. 1 is an illustration of an environment 100 in an example implementation that is operable to employ techniques for sharing protection for a screen sharing experience described herein. Generally, the environment 100 includes various devices, services, and networks that enable communication via a variety of different modalities. For instance, the environment 100 includes a client device 102 connected to a network 104. The client device 102 may be configured in a variety of ways, such as a traditional computer (e.g., a desktop personal computer, laptop computer, and so on), a mobile station, an entertainment appliance, a smartphone, a wearable device, a netbook, a game console, a handheld device (e.g., a tablet), and so forth.

The network 104 is representative of a network that provides the client device 102 with connectivity to various networks and/or services, such as the Internet. The network 104 may provide the client device 102 with connectivity via a variety of different connectivity technologies, such as broadband cable, digital subscriber line (DSL), wireless cellular, wireless data connectivity (e.g., WiFi™), T-carrier (e.g., T1), Ethernet, and so forth. In at least some implementations, the network 104 represents different interconnected wired and wireless networks.

The client device 102 includes a variety of different functionalities that enable various activities and tasks to be performed. For instance, the client device 102 includes an operating system 106, applications 108, a communication client 110, and a communication module 112. Generally, the operating system 106 is representative of functionality for abstracting various system components of the client device 102, such as hardware, kernel-level modules and services, and so forth. The operating system 106, for instance, can abstract various components of the client device 102 to the applications 108 to enable interaction between the components and the applications 108.

The applications 108 represent functionalities for performing different tasks via the client device 102. Examples of the applications 108 include a word processing application, a spreadsheet application, a web browser, a gaming application, and so forth. The applications 108 may be installed locally on the client device 102 to be executed via a local runtime environment, and/or may represent portals to remote functionality, such as cloud-based services, web apps, and so forth. Thus, the applications 108 may take a variety of forms, such as locally-executed code, portals to remotely hosted services, and so forth.

The communication client 110 is representative of functionality to enable different forms of communication via the client device 102. Examples of the communication client 110 include a voice communication application (e.g., a VoIP client), a video communication application, a messaging application, a content sharing application, a unified communication & collaboration (UC&C) application, and combinations thereof. The communication client 110, for instance, enables different communication modalities to be combined to provide diverse communication scenarios.

The communication module 112 is representative of functionality for enabling the client device 102 to communicate data over wired and/or wireless connections. For instance, the communication module 112 represents hardware and logic for data communication via a variety of different wired and/or wireless technologies and protocols.

The client device 102 further includes a display device 114, which represents functionality for visual output for the client device 102. Additionally, the display device 114 represents functionality for receiving various types of input, such as touch input, pen input, and so forth.

The environment 100 further includes endpoint devices 116, which are representative of devices and/or functionalities with which the client device 102 may communicate. In at least some implementations, the endpoint devices 116 represent end-user devices such as discussed with reference to the client device 102. The endpoint devices 116 include communication clients 118, which are representative of functionalities to enable different forms of communication via the endpoint devices 116. The communication clients 118, for example, represent different instances of the communication client 110. For purposes of discussion herein, reference is made to an endpoint device 116 and a communication client 118, which represent instances of the endpoint devices 116 and the communication clients 118, respectively.

In at least some implementations, the communication clients 110, 118 represent interfaces to a communication service 120. Generally, the communication service 120 is representative of a service to perform various tasks for management of communication between the client device 102 and the endpoint device 116. The communication service 120, for instance, can manage initiation, moderation, and termination of communication sessions between the communication clients 110, 118.

The communication service 120 maintains a presence across many different networks and can be implemented according to a variety of different architectures, such as a cloud-based service, a distributed service, a web-based service, and so forth. Examples of the communication service 120 include a VoIP service, an online conferencing service, a UC&C service, and so forth.

The communication client 110 further includes a sharing module 122, which is representative of functionality for performing various aspects of techniques for sharing protection for a screen sharing experience discussed herein. Various attributes and operational aspects of the sharing module 122 are detailed below. The sharing module 122 maintains sharing policies 124, which are representative of different sets of data that specify permissions and criteria for sharing content between the client device 102 and the endpoint devices 116. The sharing policies 124, for instance, specify which regions of the display device 114 may be shared with the endpoint devices 116, and which regions of the display device 114 may not be shared with the endpoint devices 116. Alternatively or additionally, the sharing policies 124 are content and/or application-specific. For example, the sharing policies 124 can specify certain types of content that are permitted to be shared with the endpoint devices 116, and other types of content that are not permitted to be shared with the endpoint devices 116. Further, the sharing policies 124 can specify that an application window for a particular application 108 is permitted to be shared, whereas an application window for a different application 108 is not permitted to be shared. Generally, the sharing policies 124 can be configured in various ways, such as via default settings specified by an application developer, end user-specified settings, by information technology (IT) personnel, and so forth.

The communication client 110 further maintains and/or has access to group memberships 126, which represent identifiers for different groups that a user 128 of the client device 102 is a member of. Generally, a “group” refers to a grouping of different users based on different criteria. A particular group, for instance, represents a collection of user identifiers and/or device identifiers that belong to the particular group. Generally, a group may be created and managed to control access to hardware resources, software resources, content, file systems (e.g., directories), and so forth. Examples of a group include a user group, an email group, a directory group, and so forth. In at least some implementations, sharing policies 124 identify specific privileged groups with which a sharing protected region may be shared “in the clear.” Generally, the term “in the clear” as used herein refers to the ability to view content in an unencrypted and/or unobscured form, such as enabled via decryption of encrypted content. For instance, a particular sharing policy 124 can specify that sharing protected content may be shared with a particular group, but is not to be shared with users outside of the particular group, e.g., users that are not a member of the particular group. Alternatively or additionally to designating sharing privileged groups, the sharing policies 124 may designate specific sharing privileged users, devices, network domains, and so forth.

While the sharing module 122 and the sharing policies 124 are depicted as being implemented on the client device 102, it is to be appreciated that in some additional or alternative implementations, functionality of the sharing module 122 and/or the sharing policies 124 may be partially or wholly implemented via a network-based service, such as the communication service 120. For instance, the communication service 120 may perform various aspects of techniques for sharing protection for a screen sharing experience described herein.

The client device 102 further includes an encryption module 130 and a codec 132. The encryption module 130 is representative of functionality for encrypting and decrypting data, such as for encrypting screen content as part of a screen sharing experience. For at least this purpose, the encryption module 130 includes and/or has access to encryption keys (“keys”) 134, which are representative of keys that can be used to encrypt and decrypt information. The keys 134, for instance, can be used by the encryption module 130 to encrypt sharing protected content. Sharing protected content, for instance, may be encrypted by the encryption module 130 such that an endpoint device 116 that receives the encrypted content cannot view the content in the clear unless the endpoint device 116 has access to a particular key 134 that was used to encrypt the content.

In at least some implementations, the encryption module 130 may include scrambling functionality (e.g., a scrambler) that scrambles sharing protected content to prevent the protected content from being viewed in the clear. For instance, the encryption module 130 can apply a scrambling algorithm and/or other data scrambling technique to randomize data of sharing protected content and prevent other devices from accessing the protected content in the clear. As used herein, encryption may refer to encryption that encodes data with a key, scrambling that scrambles data using a scrambling algorithm, and/or combinations thereof.

The codec 132 is representative of functionality for encoding and decoding content, such as for encoding and decoding a content stream (e.g., including video, audio, files, and so forth) that is generated as part of a screen sharing experience. The codec 132, for instance, is configured to perform compression and decompression of content data, such as to reduce transmission bandwidth required to transmit a content stream as part of a screen sharing experience.

Having described an example environment in which the techniques described herein may operate, consider now a discussion of an example implementation scenario for sharing protection for a screen sharing experience in accordance with one or more embodiments.

The following section describes some example implementation scenarios for sharing protection for a screen sharing experience in accordance with one or more implementations. The implementation scenarios may be implemented in the environment 100 discussed above, and/or any other suitable environment.

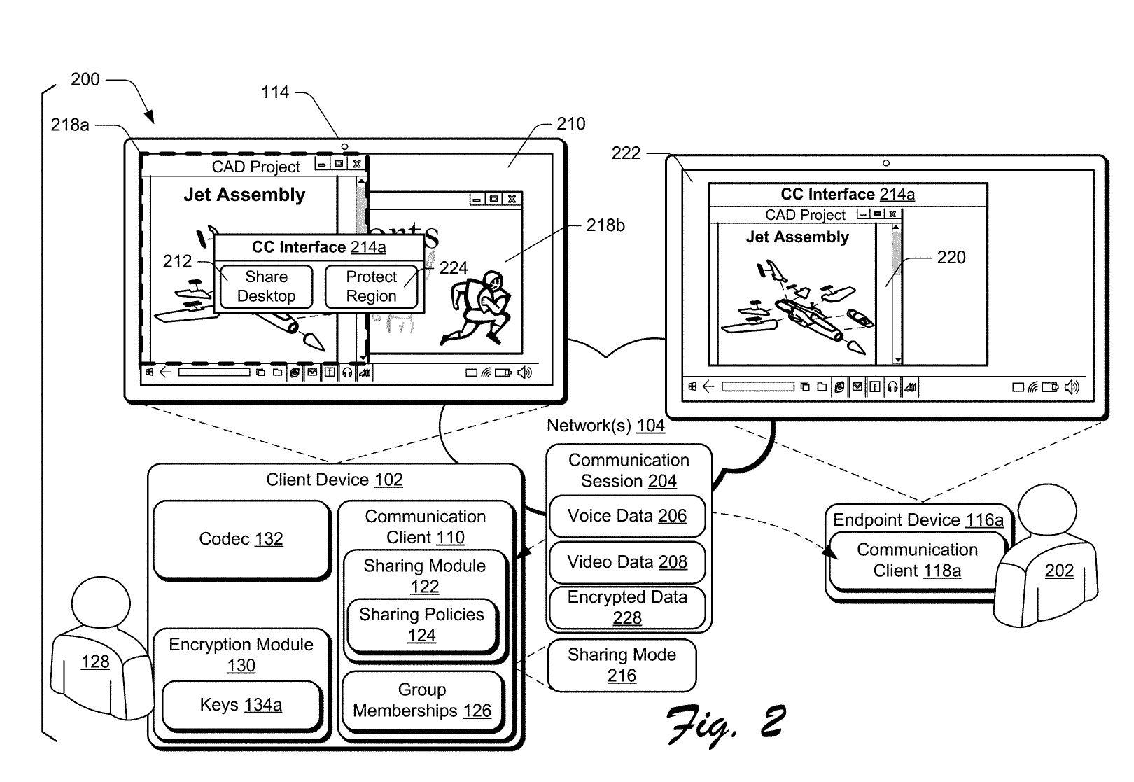

FIG. 2 depicts an example implementation scenario 200 for protecting content during a screen sharing experience in accordance with one or more implementations. The scenario 200 includes various entities and components introduced above with reference to the environment 100.

In the scenario 200, the user 128 of the client device 102 is engaged in a communication session 204 with a user 202 of an endpoint device 116a. Generally, the communication session 204 represents a real-time exchange of different communication media between the client device 102 and the endpoint device 116a, such as audio, video, files, media content, and/or combinations thereof. In this particular example, the communication session 204 involves a real-time exchange of voice data 206 and video data 208 between the client device 102 and the endpoint device 116a over the network 104.

As part of the communication session 204, the user 128 performs an action to share a portion of a desktop 210 of the display device 114 with the user 202. Generally, the desktop 210 represents a portion of the display device 114 in which different interfaces and controls for applications, tasks, system operations, and so forth, are displayed. For instance, the user 128 selects a share control 212 from a communication client interface 214a. Generally, the Communication client interface 214a represents an interface for the communication client 110 that enables the user 128 to perform various actions and view status information pertaining to the communication session 204. Selection of the share control 212 activates a sharing mode 216 that causes at least a portion of the desktop 210 to be shared with the endpoint device 116a.

Accordingly, responsive to the user action to activate the sharing mode 216, a region 218a of the desktop 210 is shared with the endpoint 116a. The user action to share the desktop 210 causes a visual representation 220 of the region 218a to be presented within a Communication client interface 214a displayed on a display 222 of the endpoint device 116a. The visual representation 220, for instance, represents a live copy of the region 218a that is communicated from the client device 102 to the endpoint device 116a as part of the video data 208. Generally, the Communication client interface 214a represents a GUI of the communication client 118.

Notice that while the region 218a is shared to the endpoint device 116a, a different region 218b of the desktop 210 is not shared to the endpoint device 116a. According to techniques for sharing protection for a screen sharing experience described herein, the region 218b is designated as a protected region that is not to be shared with the endpoint device 116a. Generally, the region 218b can be designated as a protected region in various ways, such as by a user action that identifies the region 218b as a protected region. For instance, the user 128 selects a protect control 224 from the Communication client interface 214a, which activates a sharing protect mode that enables the region 218b to be designated as sharing protected. Examples of different ways of designating protected regions of a display area are discussed below.

To enable the region 218b to be protected from sharing to the endpoint device 116a, the communication client 110 interfaces with the encryption module 130 to cause the region 218b to be encrypted, such as using a key 134a. For instance, the sharing module 122 passes a region identifier (“ID”) 226 for the region 218b to the encryption module 130, and the encryption module 130 encrypts data from the region 218b using the key 134a to generate encrypted video data 228. Generally, the region ID 226 may be implemented in various ways, such as pixel coordinates that define the region 218b, an application identifier for an application 108 that presents content within the region 218b, a file identifier for content presented within the region 218b, and so forth.

Accordingly, the encrypted video data 228 may be communicated with the data stream of the communication session 204. However, since the endpoint device 116a does not have access to the key 134a, the endpoint device 116a is not able to decrypt the encrypted video data 228 and display content from the region 218b in the clear.

In this way, different regions of a display area (e.g., a desktop) can be defined as sharing restricted to enable some portions of a display to be shared, and other portions to be protected from sharing. Generally, content can be designated as sharing protected dynamically and while the communication session 204 is in progress. For instance, the user 128 can perform actions to cause sharing protection for the region 218b to be applied and then later removed and while the communication session 204 is in progress. Alternatively or additionally, certain content can be persistently designated as sharing protected such that sharing protection is automatically applied across multiple separate communication sessions. Persistent sharing protection, for example, can be applied based on an application ID, a content type, a specific portion of the desktop 210, and so forth.

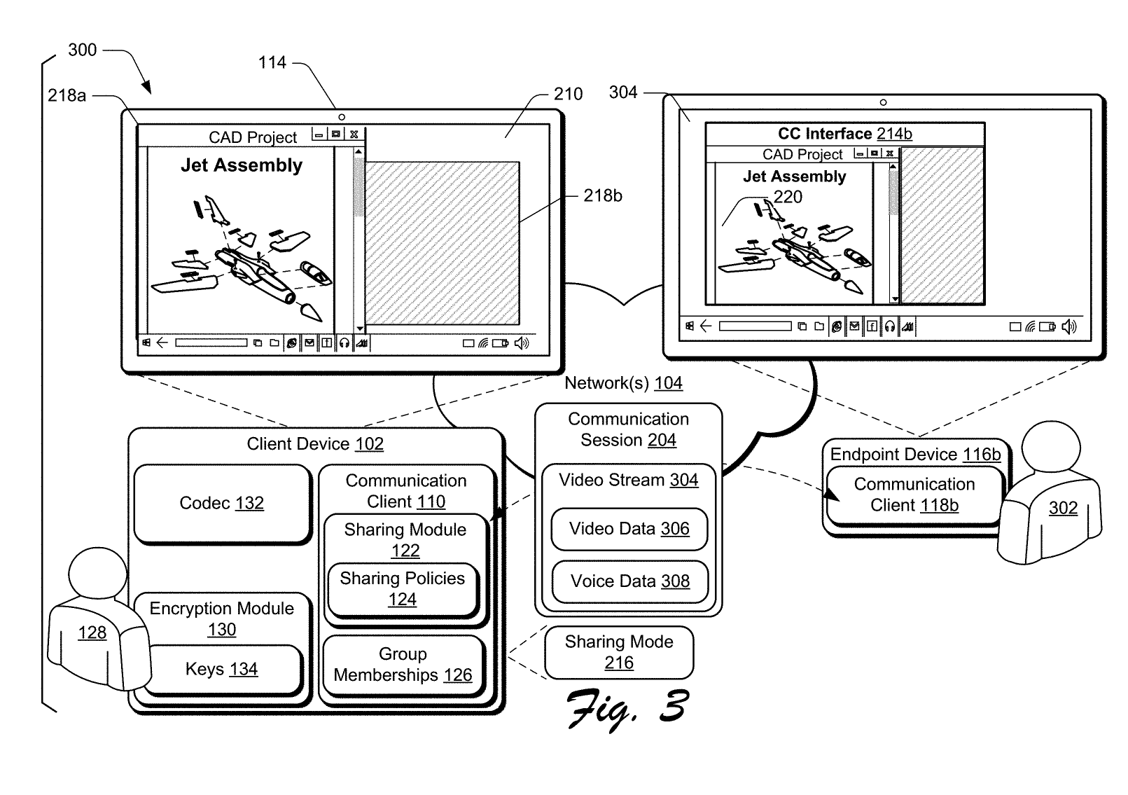

FIG. 3 depicts an example implementation scenario 300 for protecting content during a screen sharing experience in accordance with one or more implementations. The scenario 300 includes various entities and components introduced above with reference to the environment 100. In at least some implementations, the scenario 300 represents a continuation and/or variation of the scenario 200 described above.

In the scenario 300, the user 128 is participating in a screen sharing experience with a user 302 as part of the communication session 204, and designates the region 218b as sharing protected, such as described elsewhere herein. In response, the encryption module 130 encrypts content from the region 218b. In this particular scenario, however, content from the region 218b is locally encrypted such that the content is obscured on both the display 114 and a display 304 of an endpoint device 116b of the user 302. For instance, notice that the region 218b is visually obscured (e.g., scrambled) on the desktop 210, as well as in a Communication client interface 214b presented by a communication client 118b of the endpoint device 116b. In at least some implementations, visually obscuring the region 218b locally on the desktop 210 enables the entire desktop 210 to be captured and encoded by the codec 132 and transmitted to the endpoint device 116c as a single encoded video stream 304. For instance, the encoded video stream 304 includes video data 306 and voice data 306, and the video data 306 includes unobscured (e.g., unencrypted) portions of the desktop 210 (e.g., the region 218a) as well as the obscured region 218b. Thus, the entire desktop 210 can be transmitted as part of the communication session 204 without requiring the region 218b to be encrypted and communicated as a separate encrypted portion of content as part of the communication session 204.

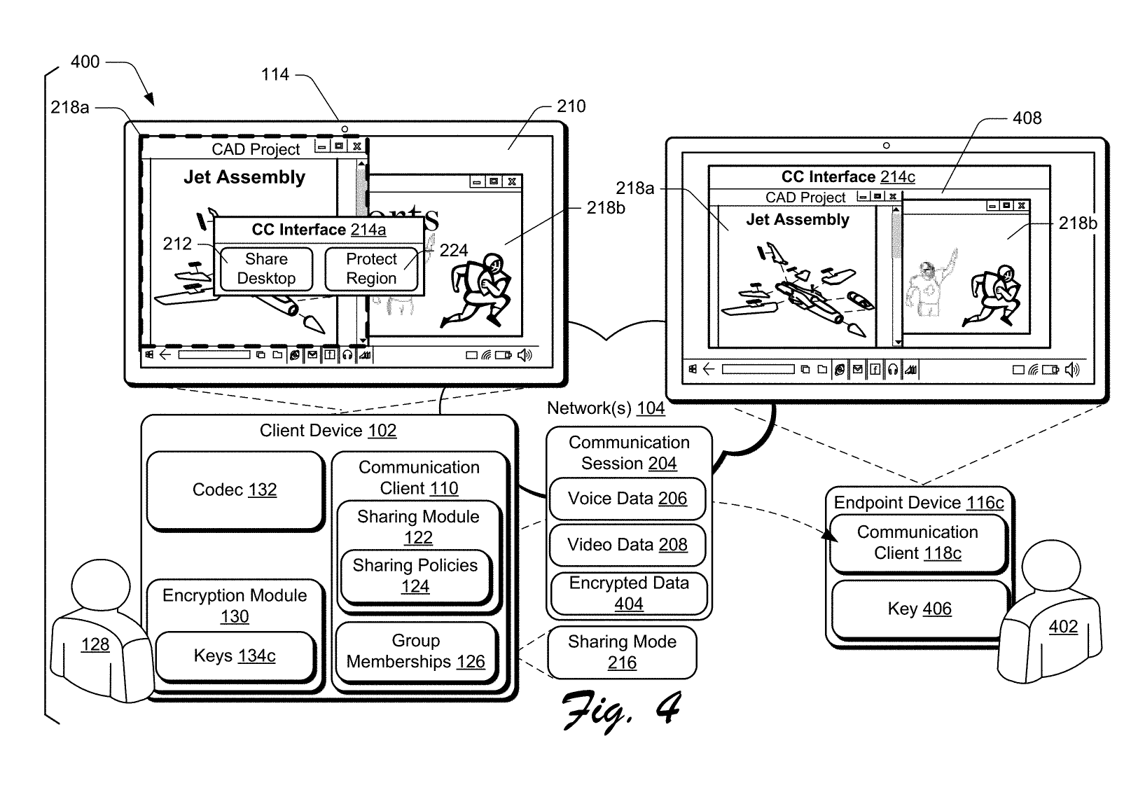

FIG. 4 depicts an example implementation scenario 400 for enabling sharing protected content to be accessible by a privileged user during a screen sharing experience in accordance with one or more implementations. The scenario 400 includes various entities and components introduced above with reference to the environment 100. In at least some implementations, the scenario 400 represents a continuation and/or variation of the scenarios 200, 300 described above.

In the scenario 400, the user 128 is participating in a screen sharing experience with a user 402 as part of the communication session 204, and designates the region 218b as sharing protected, such as described elsewhere herein. In response, the encryption module 130 encrypts content from the region 218b with an encryption key 134c to generate the encrypted video data 404. Thus, the encrypted video data 404 is transmitted to an endpoint device 118c of the user 402 along with the voice data 206 and the video data 208.

In this particular scenario, an endpoint device 116c includes and/or has access to a key 406, which represents an instance of the key 134c used to encrypt the encrypted video data 404. Accordingly, the endpoint device 116c can decrypt the encrypted video data 404 to enable a visual representation 408 of the desktop 210 to be displayed, including content from the region 218a and the region 218b in the clear as part of a Communication client interface 214c for a communication client 118c. Other endpoints 116 participating in the communication session 204 that don't have access to the key 406 may receive the encrypted video data 404, but will not be able to decrypt the encrypted data 404 and view the region 218b in the clear.

Generally, the endpoint device 116c may have access to the key 406 in various ways. For example, the key 406 may be communicated to the endpoint device 116c along with an invite to participate in the communication session 204, such as embedded in and/or attached to the invite. As another example, the key 406 may be communicated to the endpoint device 116c separately from an invite, such as part of an email, in instant message, a text message, and so forth.

In one example implementation, the key 406 may be accessible to the endpoint device 116c by virtue of the user 128 being a member of a privileged group that is entitled to access the key 406. For instance, membership in a common group entitles its users to access the key 406, and users outside of that group that are not specifically designated as sharing privileged are not entitled to access the key 406. In at least some implementations, the key 406 is available to the endpoint 116c by virtue of the user 402 and the user 128 both being members of the same group. For instance, group privileges for the group entitle its members to access the key 406.

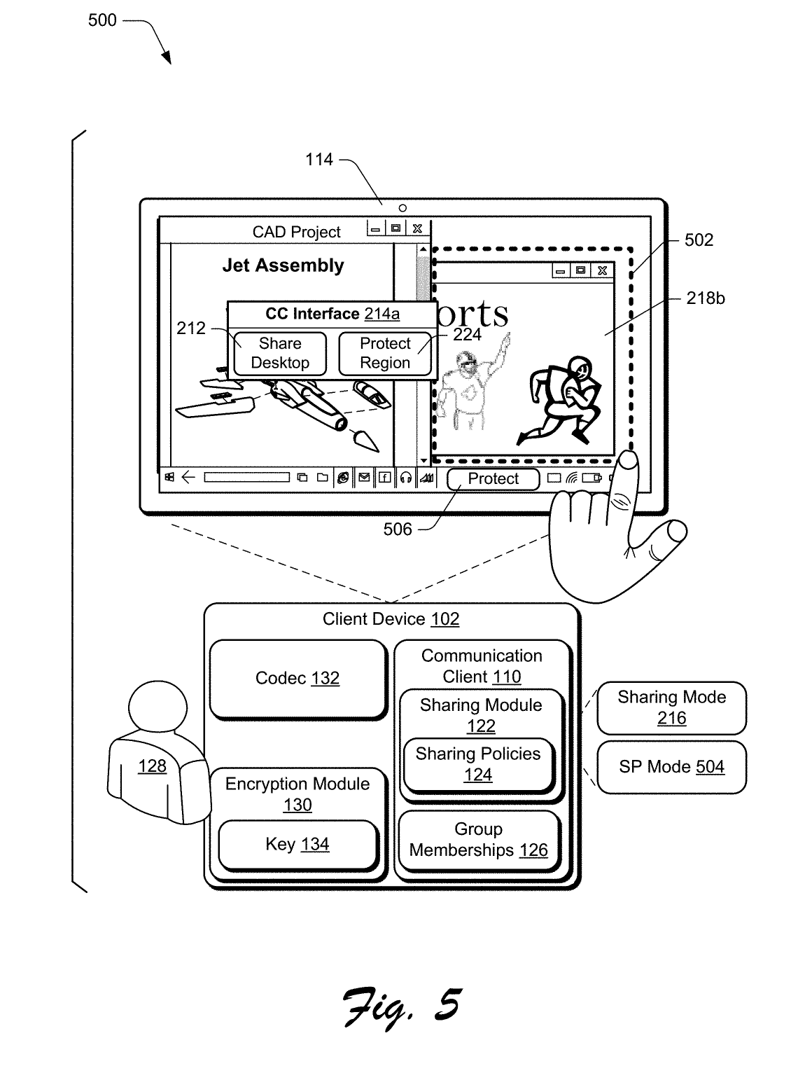

FIG. 5 depicts an example implementation scenario 500 for designating a sharing protected region in accordance with one or more implementations. The scenario 500 includes various entities and components introduced above with reference to the environment 100. In at least some implementations, the scenario 500 represents a continuation and/or variation of the scenarios 200-400 described above.

In the scenario 500, the client device 102 is in the sharing mode 216. Further, the user 128 designates the region 218b as a sharing protected region such the region 218b is not shared with another device while the sharing mode 216 is active, such as described in the scenarios above. The user 128, for instance, uses touch input to the display device 114 to draw a protect zone 502 around the region 218b. Others types of input may also be used to draw the protect zone 502, such as input using a mouse and cursor, touchless gesture input, stylus input, and so forth. In this particular example, the protect zone 502 is visually indicated via a dashed line to provide a visual affordance of a portion of the display device 114 that is designated as sharing protected.

In at least one implementation, the user 128 activates a sharing protect (“SP”) mode 504 prior to drawing the protect zone 502. Alternatively or additionally, the user 128 draws the protect zone 502 and then subsequently activates the SP mode 504. In one particular example, the SP mode 504 is activated by selecting a sharing protect (“protect”) control 506. Generally, the SP mode 504 allows a portion of a display to be designated as sharing protected. For instance, the SP mode 504 enables a protect zone to be drawn around any arbitrary portion of the display device 506, and content within the protect zone will be designated as sharing protected.

Further to the scenario 500, drawing the protect zone 502 causes the portion of the display device 114 within the protect zone 502 to be encrypted using an instance of a key 134. Example ways and implementations for encrypting sharing protected content are described above.

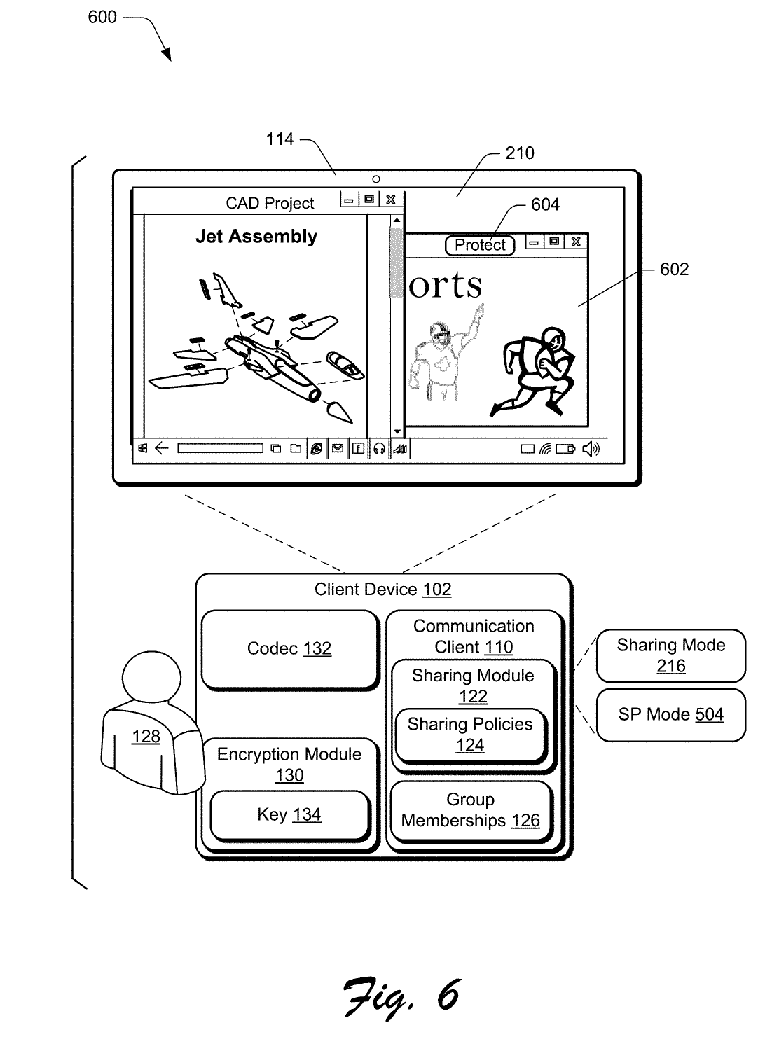

FIG. 6 depicts an example implementation scenario 600 for designating a sharing protected region in accordance with one or more implementations. The scenario 600 includes various entities and components introduced above with reference to the environment 100. The scenario 600, for instance, may be implemented in conjunction with the scenarios 200-500 described above.

In the scenario 600, the client device 102 is in the sharing mode 216, such as described above. Further, a GUI 602 includes a protect control 604. The GUI 602, for instance, represents a GUI for a particular application 108. According to implementations discussed herein, the protect control 604 is selectable to invoke the SP mode 504 for the GUI 602. For instance, in response to the user 128 selecting the protect control 604, the SP mode 504 is invoked for the GUI 402. Accordingly, the user 128 can move (e.g., drag) the GUI 602 within the display device 114, and the GUI 602 will remain sharing protected. Thus, the SP mode 504 can be bound to a particular instance of content (e.g., the GUI 402) such that the content remains sharing protected wherever the content may be displayed.

Generally, invoking the SP mode 504 for the GUI 602 causes the GUI 602 to be encrypted by the encryption module 130 using a key 134. Thus, when the desktop 210 is shared with other devices that don't have access to the key 134, content of the GUI 602 is not accessible in the clear, e.g., the content is visually obscured. However, other devices that have access to the key 134 may decrypt and view content of the GUI 602 in the clear.

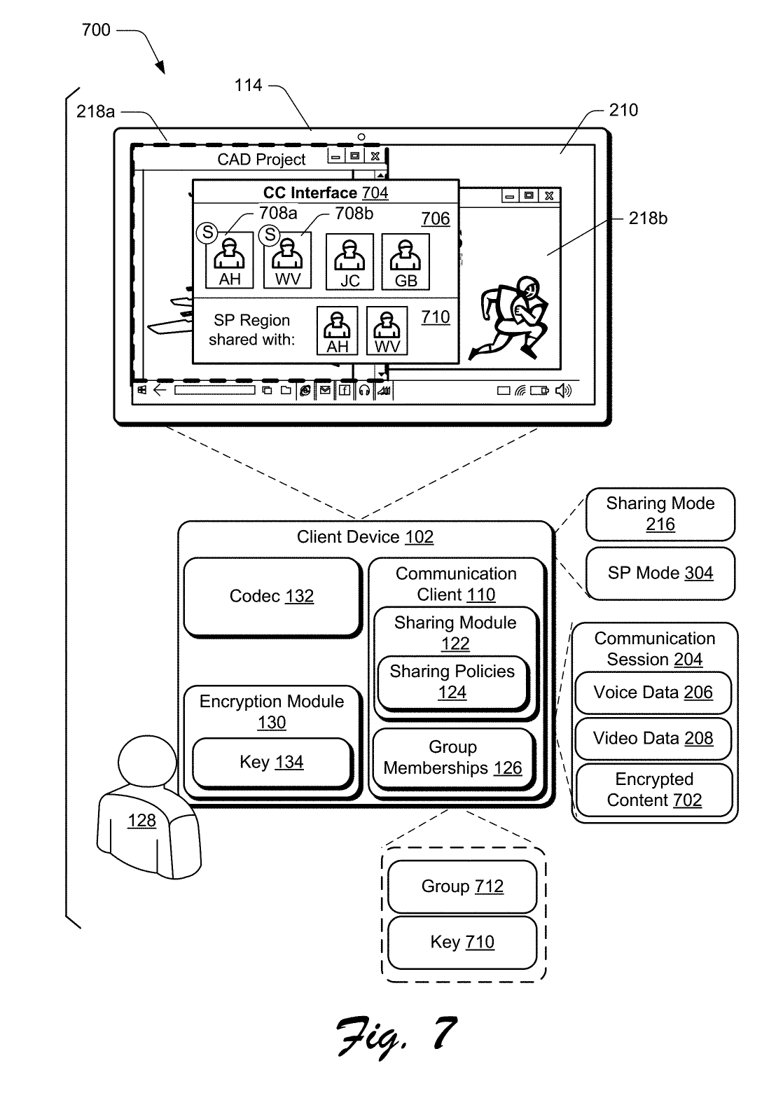

FIG. 7 depicts an example implementation scenario 700 for designating a user set that is permitted to view a sharing protected region in accordance with one or more implementations. The scenario 700 includes various entities and components introduced above with reference to the environment 100. The scenario 700, for instance, may be implemented in conjunction with the scenarios 200-600 described above.

In the scenario 700, the user 128 is participating in the communication session 204 introduced above and the sharing mode 216 is active such that a portion of the desktop 210 is shared with other devices participating in the communication session 204. Further, the region 218b is designated as sharing protected, such as described above. In response to the region 218b being designated as sharing protected, the encryption module 130 encrypts content from the region 218b with a key 134 to generate encrypted video content 702.

Further to the scenario 700, a Communication client interface 704 is displayed on the display device 114. Generally, the Communication client interface 704 represents an interface for the communication client 110 that enables the user 128 to perform various actions and view various information pertaining to the communication session 204. In this particular example, the Communication client interface 704 includes a participant region 706 that identifies different users that are connected to and participating in the communication session 204. For instance, the participant region 706 is populated with visual icons that each represent a different user that is connected to the communication session 204.

As discussed above, in at least some implementations, when a user designates a particular region of a display area as sharing protected, the region is encrypted such that other participants in a screen sharing experience are not able to view content of the region in the clear unless the participants are able the decrypt the content. Thus, implementations discussed herein enable a user to prevent a particular region from being accessible in the clear to some users, while allowing the region to be accessible in the clear for other users. The user 128, for example, can identify certain users that are permitted to view content in the clear from a region that has been designated as sharing protected.

For instance, in the Communication client interface 704, a user icon 708a and a user icon 708b in the participant region 704 are visually annotated to indicate that the users represented by the respective icons 708a, 708b are designated as privileged to view sharing protected content in the clear. The icons 708a, 708b, for instance, are annotated with the letter “S” to indicate that the respective users are sharing privileged.

Generally, the user 128 can designate the users as sharing privileged in various ways. For instance, the user 202 can select the individual icons 708a, 708b, such as via a right click with a mouse, a press and hold touch gesture, a touchless hand gesture, and so forth. In response to the selection, the user 202 can be presented with a selectable option that enables the icons 708a, 708b to be designated as privileged.

Alternatively or additionally, the user 128 can drag the icons 708a, 708b from the participant region 706 into a privileged region 708 of the Communication client interface 702, which causes the respective users to be designated as sharing privileged. The privileged region 708, for instance, is populated with the icons 708a, 708b to indicate that the respective users are designated as sharing privileged such that the users are able to obtain an encryption key for decrypting sharing protected content.

Further to the scenario 700, in response to users represented by the icons 708a, 708b being designated as sharing privileged, a key 710 is made available to the privileged users. According to various implementations, the key 710 represents an instance (e.g., a copy) of the key 134 that was used to encrypt the encrypted content 702. The key 710, for instance, can be communicated to the privileged users, such as via email, Internet messaging, text messaging, and so forth. Alternatively or additionally, the key 710 can be communicated directly to respective instances of the communication clients 118 that reside on endpoint devices 116 associated with the privileged users. As yet another implementation, the key 710 can be stored at a remote location that is accessible to the privileged users, such as a network storage that is remote from endpoint devices 116 associated with the respective users.

As discussed above, access to a key for decrypting sharing protected content can be based on group membership. Thus, in at least some implementations, the key 710 can be shared with the privileged users via associating the key 710 with a particular group. For instance, in response to the users being designated as privileged users, the users may be added as members of a group 712 that has access to the key 710. Thus, endpoint devices 118 associated with the privileged users may access the key 710, such as by accessing a network storage that stores content for the group 712. Alternatively, the privileged users may already be members of the group 712, and thus the group 712 may be designated as a privileged group in response to the users being designated as privileged. Thus, by virtue of being members of the group 712, the privileged users represented by the icons 706a, 706b may access the key 710 and decrypt the encrypted content 702 to enable the privileged users to view the content from the region 218b in the clear.

If the user 128 wishes to rescind sharing privilege for a particular user, the user 128 can perform an action to do so. For instance, the user 128 can select an individual icon 706a, 706b and be presented with an option to discontinue sharing privilege for the respective user. If the user 128 selects the option, sharing privilege for the user will be rescinded such that content that is designated as sharing privileged will no longer be accessible to the user. Alternatively or additionally, the user 128 can drag an icon 706a, 706b from the privileged region 708 to the participant region 704, which causes sharing privilege for the respective user to be deactivated. Generally, rescinding sharing privilege can occur in various ways. For instance, access to the key 710 can be rescinded such that the user is no longer able to access the key 710 and decrypt the encrypted content 702.

Alternatively, a different key 134 can be selected for encrypting sharing protected content to generate the encrypted content 702 such that the key 710 is no longer effective to decrypt the encrypted content 702. In such a case, the different key can be distributed and/or made available to other users that remain sharing privileged, but not to the user who's sharing privilege is rescinded.

In at least some implementations, users can be designated as privileged and non-privileged dynamically, such as while the communication session 204 is in progress. For instance, consider that the user has designated the region 218b as sharing protected, such as described above. Further, while the communication session 204 is in progress, the user 128 wants to temporarily share the region 218b with a subset of participants in the communication session 204. Accordingly, while the communication session 204 is ongoing, the user can perform an action to designate users represented by the icons 706a, 706b as sharing privileged. In response, the region 218b will transition from being sharing protected from the users, to being shared with the users such that the users can view the region 218b at their respective devices in the clear while the region 218b remains sharing protected to other non-privileged users that are participating in the communication session. If the user 128 later decides while the communication session 204 is in progress to sharing protect the region 218b from the users, the user 128 can rescind sharing privilege from the users, such as described above. Thus, implementations for sharing protection for a screen sharing experience enable sharing protected regions to be temporarily shared with different users while a communication session is in progress.

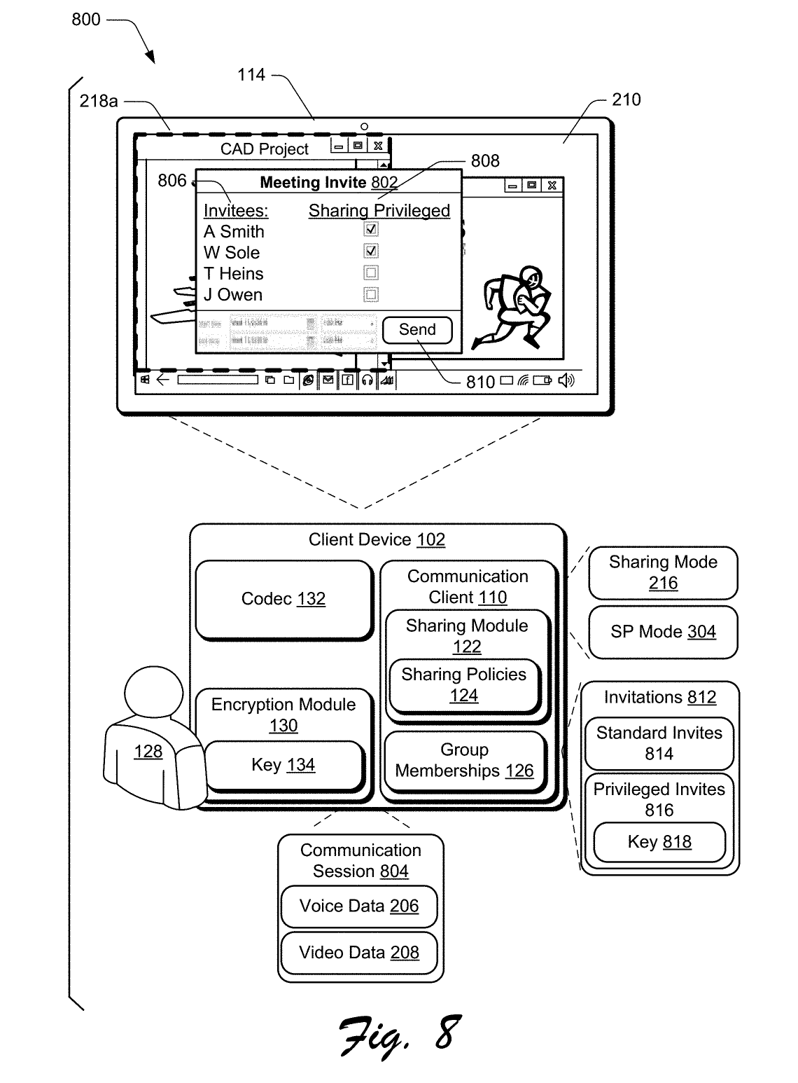

FIG. 8 depicts an example implementation scenario 800 for designating users that are sharing privileged in accordance with one or more implementations. The scenario 800 includes various entities and components introduced above with reference to the environment 100. The scenario 800, for instance, may be implemented in conjunction with the scenarios 200-700 described above.

The scenario 800 includes a meeting invitation GUI (“Invite GUI”) 802, which represents a GUI for generating an invitation for different users to participate in a communication session 804 implemented via the communication client 110. The communication session 804, for instance, represents a communication session that is to occur at a future point in time. The invite GUI 802 includes an invitees region 806 and a sharing privileged region 808. Generally, the invitees region 806 enables the user 128 to specify different users that are to be invited to participate in a communication session. The sharing privileged region 808 enables the user 128 to indicate whether particular users identified in the invitees region are to be sharing privileged. In this particular example, the sharing privileged region 808 includes selectable controls that enables sharing privileged status for individual users to be selected and deselected. For instance, in this example the users “A Smith” and “W Sole” are designated as sharing privileged, whereas the users “T Heins” and “J Owen” are not.

The invite GUI 802 includes a send control 810, which is selectable to cause invitations 812 to participate in the communication session 804 to be sent to the invitees identified in the invitees region 804. Generally, the invitations 810 may be sent in various ways, such as via email, Internet messaging, application-application communication (e.g., between different instances of the communication clients 110), and so forth.

Generally, the invitations 810 include standard invites 814 and privileged invites 816. The standard invites 814 are sent to invitees that are not designated as sharing privileged, e.g., “T Heins” and “J Owen.” The privileged invites 816, however, are sent to invitees that are designated as privileged, e.g., “A Smith” and “W Sole.” The privileged invites 816, for instance, provide access to a key 818 that can be used to decrypt content that is designated as sharing protected as part of the communication session 804. The key 818, for instance, can be attached to the privileged invites 816, but not to the standard invites 812. Alternatively or additionally, the privileged invites 816 can include a link (e.g., a hyperlink) or other pointer to a network location where the key 818 can be retrieved, such as a secure network storage location. For instance, a privileged invite 816 can include a pointer to the key 818 without including the key 818 itself. In yet another example implementation, sending the privileged invites 816 causes the sharing privileged users to be added to a privileged group that is permitted access to the key 818.

In contrast, the standard invites 814 do not provide access to the key 818, and thus do not enable the non-sharing privileged invitees to access the key and decrypt sharing protected content included as part of the communication session 804. In a scenario where group access is employed, the standard invites 814 do not cause the non-sharing privileged users to be added to the sharing privileged group.

Thus, these example scenarios demonstrate that techniques for sharing protection for a screen sharing experience enable screen content to be sharing protected as part of a screen sharing experience, and enable certain participants in the screen sharing experience to view sharing protected content in the clear.

Having discussed some example implementation scenarios, consider now a discussion of some example procedures in accordance with one or more embodiments.

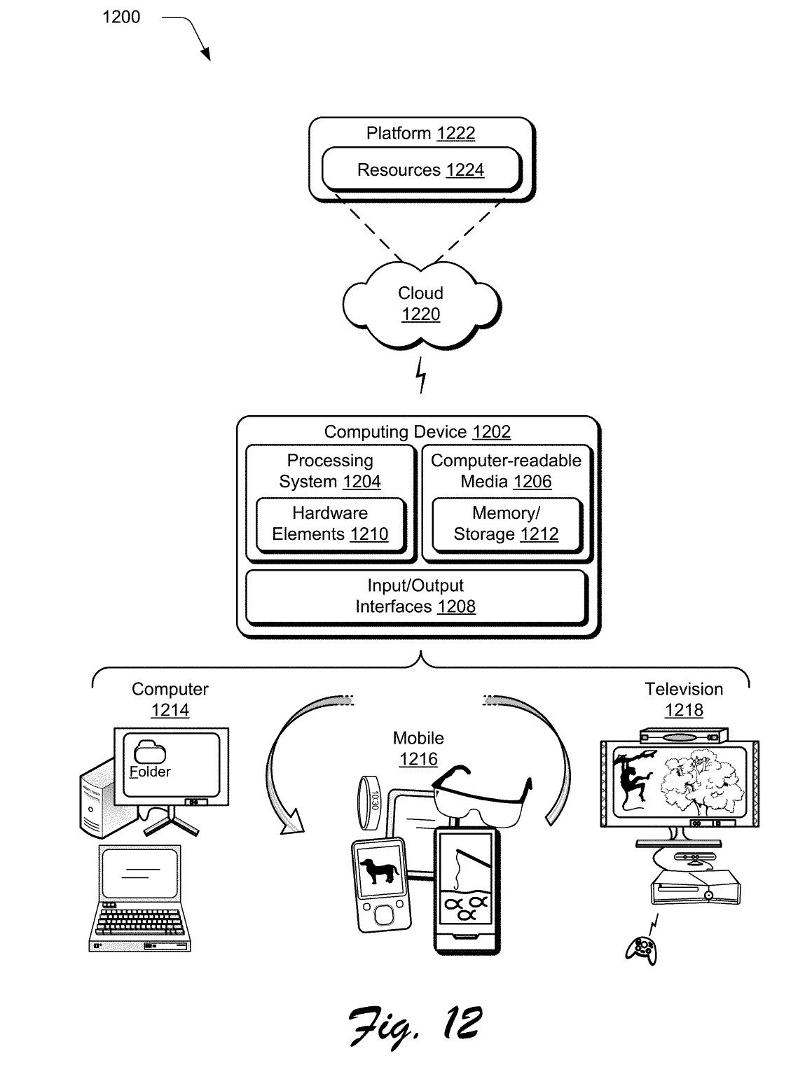

The following discussion describes some example procedures for sharing protection for a screen sharing experience in accordance with one or more embodiments. The example procedures may be employed in the environment 100 of FIG. 1, the system 1200 of FIG. 12, and/or any other suitable environment. The procedures, for instance, represent example procedures for implementing the implementation scenarios described above. In at least some implementations, the steps described for the various procedures are implemented automatically and independent of user interaction. According to various implementations, the procedures may be performed locally (e.g., at the client device 102) and/or at a network-based service, such as the communication service 120.

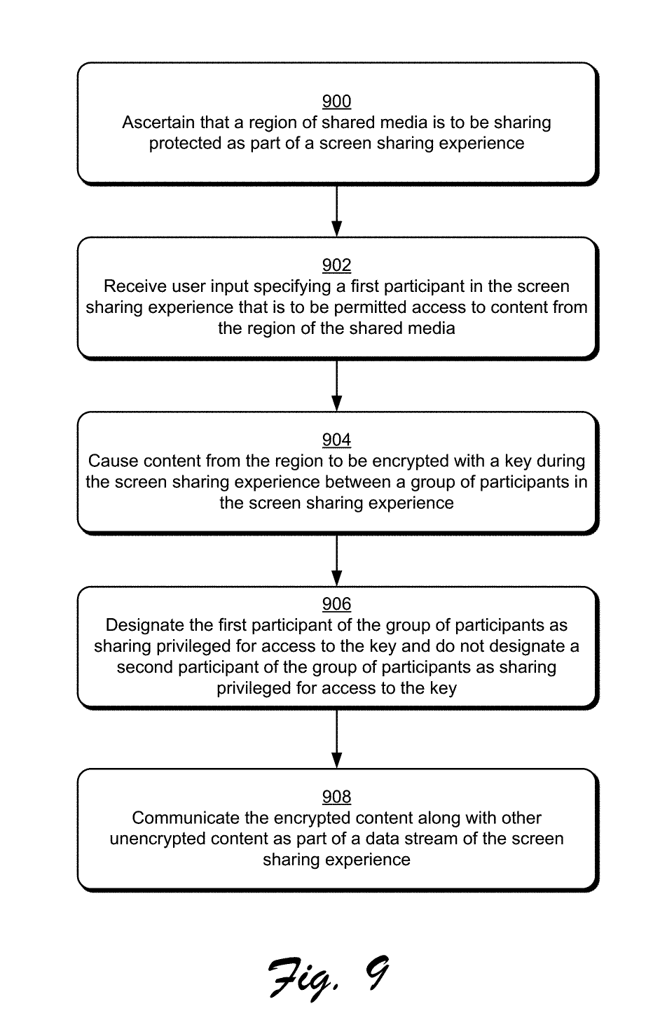

FIG. 9 is a flow diagram that describes steps in a method in accordance with one or more implementations. The method describes an example procedure for controlling access to content of a sharing protected region in accordance with one or more implementations. In at least some implementations, the method may be performed at least in part at the client device 102 (e.g., by the communication client 110) and/or by the communication service 120.

Step 900 ascertains that a region of shared media is to be sharing protected as part of a screen sharing experience. A user, for instance, selects a particular region of a display area and/or a particular content type that is to be sharing protected. Other ways of selecting sharing protected content may additionally or alternatively be employed, such as via selection of content in a virtual/mixed reality environment, selection of content displayed on a remote display device, and so forth. Example ways of designating a display region and/or particular content (e.g., “shared media”) as sharing protected are discussed above.

Step 902 receives user input specifying a first participant in the screen sharing experience that is to be permitted access to content from the region of the shared media. Different ways of specifying a sharing privileged user are described above.

Step 904 causes content from the region to be encrypted with a key during the screen sharing experience between a group of participants in the screen sharing experience. The encryption module 130, for instance, encrypts the content with an encryption key 134 to generate encrypted content.

Step 906 designates a first participant of the group of participants as sharing privileged for access to the key and does not designate a second participant of the group of participants as sharing privileged for access to the key. Generally, this permits the key to be accessible for the first participant to enable the content to be decrypted for the first participant as part of the screen sharing experience, but does not permit the key to be accessible for the second participant as part of the screen sharing experience. For instance, a first device associated with the first participant is permitted access to the key to enable the first device to decrypt the content as part of the screen sharing experience, but a second device associated with the second participant is not permitted access to the key as part of the screen sharing experience.

Step 908 communicates the encrypted content along with other unencrypted content as part of a data stream of the screen sharing experience. In at least some implementations, the screen sharing experience is part of a real-time communication session. Thus, portions of a display region can be encrypted and included in the data stream, whereas other portions may be included in the data stream in an unencrypted form.

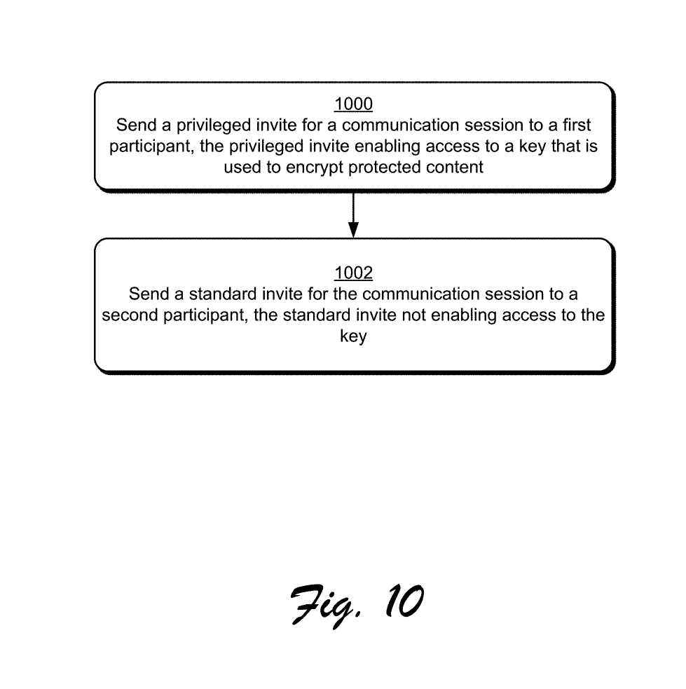

FIG. 10 is a flow diagram that describes steps in a method in accordance with one or more implementations. The method describes an example procedure for controlling access to content of a sharing protected region in accordance with one or more implementations. In at least some implementations, the method may be performed at least in part at the client device 102 (e.g., by the communication client 110) and/or by the communication service 120.

Step 1000 sends a privileged invite for a communication session to a first participant, the privileged invite enabling access to a key that is used to encrypt protected content. The communication client 110, for instance, communicates a privileged invite to a user that is designated as sharing privileged. According to various implementations, the privileged invite enables access to an encryption key for encrypting encrypted protected content. For instance, a first device associated with the first participant can utilize information associated with the invite to access the key and decrypt encrypted content.

Step 1002 sends a standard invite for the communication session to a second participant, the standard invite not enabling access to the key. The standard invite, for instance, enables the first participant to participate in the communication session, but not to decrypt protected content that is transmitted in an encrypted form as part of the communication session.

Generally, the aforementioned procedures can be performed dynamically and in real time while a screen sharing experience (e.g., a communication session) is active. For instance, while the screen sharing experience is active, a sharing user can designate a user as sharing privileged such that the different user's device is able to access an encryption key for decrypting protected content. Further, while the screen sharing experience is still active, the sharing user can revoke the sharing privileged status of the user such that the user's permission to access an encryption key for decrypting the content is revoked

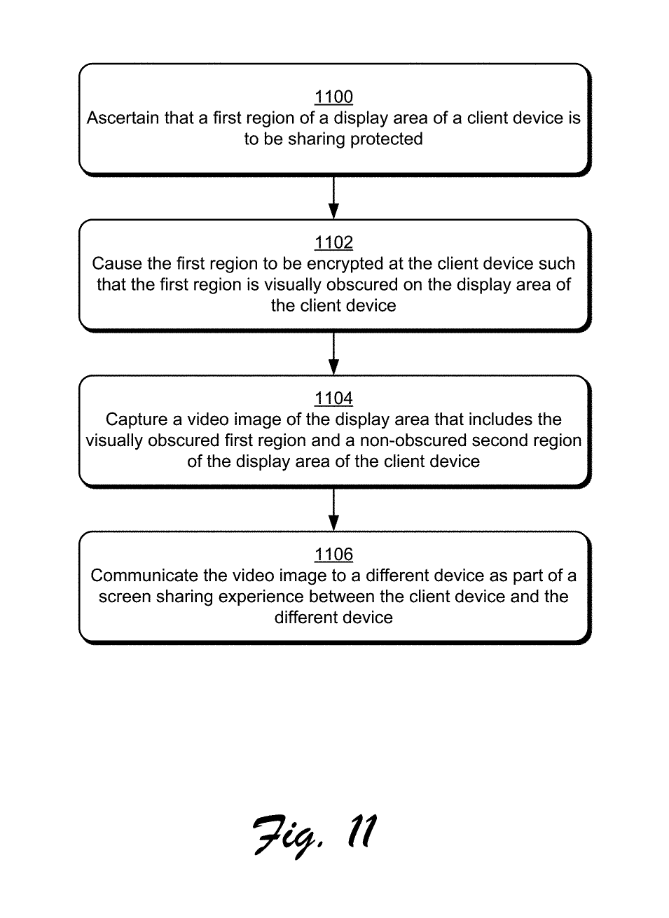

FIG. 11 is a flow diagram that describes steps in a method in accordance with one or more implementations. The method describes an example procedure for visually obscuring a sharing protected region in accordance with one or more implementations. In at least some implementations, the method may be performed at least in part at the client device 102 (e.g., by the communication client 110) and/or by the communication service 120.

Step 1100 ascertains that a first region of a display area of a client device is to be sharing protected. A user, for instance, provides input to identify a portion of a display area that is to be sharing protected.

Step 1102 causes the first region to be encrypted at the client device such that the first region is visually obscured on the display area of the client device. For instance, responsive to ascertaining that the first region of the display area is to be sharing protected, content from the first region is encrypted.

Step 1104 captures a video image of the display area that includes the visually obscured first region and a non-obscured second region of the display area of the client device. A different region of the display area, for instance, is not designated as sharing protected and is thus not encrypted. Accordingly, the encrypted first region and the non-encrypted second region can be captured together as a single video image of a display area. According to various implementations, the single video image represents a real-time image that is captured over a period of time, such as part of a real-time communication session.

Step 1106 communicates the video image to a different device as part of a screen sharing experience between the client device and the different device. For example, the video image is communicated as part of a data stream between the client device and the different device, such as part of a real-time communication session between the devices.

According to implementations discussed herein, the procedures described above can be performed multiple times during a communication session to designate sharing protected regions of a display area, and to identity users that are sharing privileged.

Accordingly, techniques discussed herein provide a wide variety of scenarios and implementations for allowing some content to be shared during a screen sharing experience, while protecting other content from being accessed in the clear during the experience. This enhances the ability of a user to share certain content during a screen sharing experience, while protecting other sensitive content during the experience.

Having discussed some example procedures, consider now a discussion of an example system and device in accordance with one or more embodiments.

FIG. 12 illustrates an example system generally at 1200 that includes an example computing device 1202 that is representative of one or more computing systems and/or devices that may implement various techniques described herein. For example, the client device 102, the endpoint devices 116, and/or the communication service 120 discussed above with reference to FIG. 1 can be embodied as the computing device 1202. The computing device 1202 may be, for example, a server of a service provider, a device associated with the client (e.g., a client device), an on-chip system, and/or any other suitable computing device or computing system.

The example computing device 1202 as illustrated includes a processing system 1204, one or more computer-readable media 1206, and one or more Input/Output (I/O) Interfaces 1208 that are communicatively coupled, one to another. Although not shown, the computing device 1202 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1204 is representative of functionality to perform one or more operations using hardware. Accordingly, the processing system 1204 is illustrated as including hardware element 1210 that may be configured as processors, functional blocks, and so forth. This may include implementation in hardware as an application specific integrated circuit or other logic device formed using one or more semiconductors. The hardware elements 1210 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1206 is illustrated as including memory/storage 1212. The memory/storage 1212 represents memory/storage capacity associated with one or more computer-readable media. The memory/storage 1212 may include volatile media (such as random access memory (RAM)) and/or nonvolatile media (such as read only memory (ROM), Flash memory, optical disks, magnetic disks, and so forth). The memory/storage 1212 may include fixed media (e.g., RAM, ROM, a fixed hard drive, and so on) as well as removable media (e.g., Flash memory, a removable hard drive, an optical disc, and so forth). The computer-readable media 1206 may be configured in a variety of other ways as further described below.

Input/output interface(s) 1208 are representative of functionality to allow a user to enter commands and information to computing device 1202, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 1202 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “entity,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1202. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1202, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 1210 and computer-readable media 1206 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 1210. The computing device 1202 may be configured to implement particular instructions and/or functions corresponding to the software and/or hardware modules. Accordingly, implementation of modules that are executable by the computing device 1202 as software may be achieved at least partially in hardware, e.g., through use of computer-readable storage media and/or hardware elements 1210 of the processing system. The instructions and/or functions may be executable/operable by one or more articles of manufacture (for example, one or more computing devices 1202 and/or processing systems 1204) to implement techniques, modules, and examples described herein.

As further illustrated in FIG. 12, the example system 1200 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1200, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1202 may assume a variety of different configurations, such as for computer 1214, mobile 1216, and television 1218 uses. Each of these configurations includes devices that may have generally different constructs and capabilities, and thus the computing device 1202 may be configured according to one or more of the different device classes. For instance, the computing device 1202 may be implemented as the computer 1214 class of a device that includes a personal computer, desktop computer, a multi-screen computer, laptop computer, netbook, and so on.

The computing device 1202 may also be implemented as the mobile 1216 class of device that includes mobile devices, such as a mobile phone, portable music player, portable gaming device, a tablet computer, a wearable device, a multi-screen computer, and so on. The computing device 1202 may also be implemented as the television 1218 class of device that includes devices having or connected to generally larger screens in casual viewing environments. These devices include televisions, set-top boxes, gaming consoles, and so on.

The techniques described herein may be supported by these various configurations of the computing device 1202 and are not limited to the specific examples of the techniques described herein. For example, functionalities discussed with reference to the sharing module 122, the encryption module 130, and/or the communication service 120 may be implemented all or in part through use of a distributed system, such as over a “cloud” 1220 via a platform 1222 as described below.

The cloud 1220 includes and/or is representative of a platform 1222 for resources 1224. The platform 1222 abstracts underlying functionality of hardware (e.g., servers) and software resources of the cloud 1220. The resources 1224 may include applications and/or data that can be utilized while computer processing is executed on servers that are remote from the computing device 1202. Resources 1224 can also include services provided over the Internet and/or through a subscriber network, such as a cellular or Wi-Fi network.

The platform 1222 may abstract resources and functions to connect the computing device 1202 with other computing devices. The platform 1222 may also serve to abstract scaling of resources to provide a corresponding level of scale to encountered demand for the resources 1224 that are implemented via the platform 1222. Accordingly, in an interconnected device embodiment, implementation of functionality described herein may be distributed throughout the system 1200. For example, the functionality may be implemented in part on the computing device 1202 as well as via the platform 1222 that abstracts the functionality of the cloud 1220.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 1200.

Techniques for sharing protection for a screen sharing experience are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments:

A system for protecting media for a screen sharing experience, the system comprising: at least one processor; and one or more computer-readable storage media including instructions stored thereon that, responsive to execution by the at least one processor, cause the system perform operations including: ascertaining that a region of shared media is to be sharing protected as part of a screen sharing experience; causing content from the region to be encrypted with a key during the screen sharing experience between a group of participants in the screen sharing experience; and designating a first participant of the group of participants as sharing privileged such that the key is permitted to be accessible for the first participant to enable the content to be decrypted for the first participant as part of the screen sharing experience, and a second participant of the group of participants is not designated as sharing privileged such that the key is not permitted to be accessible for the second participant as part of the screen sharing experience.

In addition to any of the above described systems, any one or combination of: wherein said ascertaining is responsive to user input identifying the region of shared media; wherein the region of shared media corresponds to a region of a display area of a client device; wherein said designating permits the key to be accessible to a first device associated with the first participant, but does not permit the key to be accessible to a second device associated with the second participant; wherein the screen sharing experience comprises a communication session, and wherein said designating the first participant as sharing privileged is based on user input specifying the first participant as being a privileged user, the user input comprising user interaction with a meeting invite for the communication session; wherein the screen sharing experience comprises a communication session, and wherein said designating the first participant as sharing privileged causes the key to be attached to a meeting invite for the communication session that is sent to the first participant; wherein the screen sharing experience comprises a communication session, and wherein said designating the first participant as sharing privileged causes a pointer to the key included with a meeting invite for the communication session that is sent to the first participant; wherein said designating the first participant as sharing privileged is based on a group membership of the first participant, and wherein the key is accessible to members of the group; wherein the screen sharing experience comprises a communication session, and wherein the operations further include: sending a privileged invite for the communication session to the first participant, the privileged invite enabling access to the key; and sending a standard invite for the communication session to the second participant, the standard invite not enabling access to the key; wherein the operations further include causing a data stream to be communicated to a first device associated with the first participant and a second device associated with the second participant as part of the screen sharing experience, the data stream including encrypted content from the region along with different content from a different region of the shared media that is not encrypted with the key; wherein the region of shared media corresponds to a region of a display device of a client device, the screen sharing experience comprises a real-time communication session that includes the client device, a first device associated with the first participant, and a second device associated with the second participant, and wherein said causing and said designating are performed dynamically during the communication session.

A computer-implemented method for protecting media for a screen sharing experience, the method comprising: ascertaining that a first region of a display area of a client device is to be sharing protected; causing, responsive to said ascertaining, the first region to be encrypted at the client device such that the first region is visually obscured on the display area of the client device; capturing a video image of the display area that includes the visually obscured first region and a non-obscured second region of the display area of the client device; and communicating the video image to a different device as part of a screen sharing experience between the client device and the different device.

In addition to any of the above described methods, any one or combination of: further comprising encoding the video image as a single encoded data stream, and wherein said communicating comprises communicating the single encoded video stream to the different device to enable a visual representation of the obscured first region and the non-obscured second region to be displayed at the different device; wherein the screen sharing experience comprises a real-time communication session that includes the client device and the different device; wherein said ascertaining is based on user input identifying the first region as sharing protected.

A computer-implemented method for protecting media for a screen sharing experience, the method comprising: ascertaining that a region of shared media is to be sharing protected as part of a screen sharing experience; receiving user input specifying a first participant in the screen sharing experience that is to be permitted access to content from the region of the shared media; causing content from the region to be encrypted with a key during the screen sharing experience between a group of participants in the screen sharing experience; and designating the first participant of the group of participants as sharing privileged such that the key is permitted to be accessible for the first participant to enable the content to be decrypted for the first participant as part of the screen sharing experience, and a second participant of the group of participants is not designated as sharing privileged such that the key is not permitted to be accessible for the second participant as part of the screen sharing experience.

In addition to any of the above described methods, any one or combination of: wherein the screen sharing experience comprises a communication session, and wherein said designating the first participant as sharing privileged causes the key to be attached to a meeting invite for the communication session that is sent to the first participant; wherein the screen sharing experience comprises a communication session, and wherein said designating the first participant as sharing privileged causes a pointer to the key included with a meeting invite for the communication session that is sent to the first participant, the meeting invite not including a copy of the key; wherein screen sharing experience comprises a communication session, and wherein the user input comprises user configuration of an invite to the communication session; wherein said designating the first participant as sharing privileged is based on a group membership of the first participant, and wherein the key is accessible to members of the group.

What is claimed is:

1. A system comprising:
at least one processor; and
one or more computer-readable storage media including instructions stored thereon that, responsive to execution by the at least one processor, cause the system perform operations including:
ascertaining that a region of shared media is to be sharing protected as part of a screen sharing experience;
causing content from the region to be encrypted with a key during the screen sharing experience between a group of participants in the screen sharing experience; and
designating a first participant of the group of participants as sharing privileged such that the key is permitted to be accessible for the first participant to enable the content to be decrypted for the first participant as part of the screen sharing experience, and a second participant of the group of participants is not designated as sharing privileged such that the key is not permitted to be accessible for the second participant as part of the screen sharing experience.

2. A system as recited in claim 1, wherein said ascertaining is responsive to user input identifying the region of shared media.

3. A system as recited in claim 1, wherein the region of shared media corresponds to a region of a display area of a client device.

4. A system as recited in claim 1, wherein said designating permits the key to be accessible to a first device associated with the first participant, but does not permit the key to be accessible to a second device associated with the second participant.

5. A system as recited in claim 1, wherein the screen sharing experience comprises a communication session, and wherein said designating the first participant as sharing privileged is based on user input specifying the first participant as being a privileged user, the user input comprising user interaction with a meeting invite for the communication session.

6. A system as recited in claim 1, wherein the screen sharing experience comprises a communication session, and wherein said designating the first participant as sharing privileged causes the key to be attached to a meeting invite for the communication session that is sent to the first participant.

7. A system as recited in claim 1, wherein the screen sharing experience comprises a communication session, and wherein said designating the first participant as sharing privileged causes a pointer to the key included with a meeting invite for the communication session that is sent to the first participant.

8. A system as recited in claim 1, wherein said designating the first participant as sharing privileged is based on a group membership of the first participant, and wherein the key is accessible to members of the group.

9. A system as recited in claim 1, wherein the screen sharing experience comprises a communication session, and wherein the operations further include:
sending a privileged invite for the communication session to the first participant, the privileged invite enabling access to the key; and
sending a standard invite for the communication session to the second participant, the standard invite not enabling access to the key.

10. A system as recited in claim 1, wherein the operations further include causing a data stream to be communicated to a first device associated with the first participant and a second device associated with the second participant as part of the screen sharing experience, the data stream including encrypted content from the region along with different content from a different region of the shared media that is not encrypted with the key.

11. A system as recited in claim 1, wherein the region of shared media corresponds to a region of a display device of a client device, the screen sharing experience comprises a real-time communication session that includes the client device, a first device associated with the first participant, and a second device associated with the second participant, and wherein said causing and said designating are performed dynamically during the communication session.

12. A computer-implemented method, comprising:
ascertaining that a first region of a display area of a client device is to be sharing protected;
causing, responsive to said ascertaining, the first region to be encrypted at the client device such that the first region is visually obscured on the display area of the client device;
capturing a video image of the display area that includes the visually obscured first region and a non-obscured second region of the display area of the client device; and
communicating the video image to a different device as part of a screen sharing experience between the client device and the different device.

13. A method as described in claim 12, further comprising encoding the video image as a single encoded data stream, and wherein said communicating comprises communicating the single encoded video stream to the different device to enable a visual representation of the obscured first region and the non-obscured second region to be displayed at the different device.

14. A method as described in claim 12, wherein the screen sharing experience comprises a real-time communication session that includes the client device and the different device.

15. A method as described in claim 12, wherein said ascertaining is based on user input identifying the first region as sharing protected.

16. A computer-implemented method, comprising:
ascertaining that a region of shared media is to be sharing protected as part of a screen sharing experience;
receiving user input specifying a first participant in the screen sharing experience that is to be permitted access to content from the region of the shared media;
causing content from the region to be encrypted with a key during the screen sharing experience between a group of participants in the screen sharing experience; and
designating the first participant of the group of participants as sharing privileged such that the key is permitted to be accessible for the first participant to enable the content to be decrypted for the first participant as part of the screen sharing experience, and a second participant of the group of participants is not designated as sharing privileged such that the key is not permitted to be accessible for the second participant as part of the screen sharing experience.

17. A method as described in claim 16, wherein the screen sharing experience comprises a communication session, and wherein said designating the first participant as sharing privileged causes the key to be attached to a meeting invite for the communication session that is sent to the first participant.

18. A method as described in claim 16, wherein the screen sharing experience comprises a communication session, and wherein said designating the first participant as sharing privileged causes a pointer to the key included with a meeting invite for the communication session that is sent to the first participant, the meeting invite not including a copy of the key.

19. A method as described in claim 16, wherein screen sharing experience comprises a communication session, and wherein the user input comprises user configuration of an invite to the communication session.

20. A method as described in claim 16, wherein said designating the first participant as sharing privileged is based on a group membership of the first participant, and wherein the key is accessible to members of the group.
